(19) United States
(12) Patent Application Publication
(10) Pub. No.: US 2008/0248226 A1
(43) Pub. Date: Oct. 9, 2008

(54) MULTI-LAYER TUBES

(75) Inventors: Mark W. Simon, Pascoag, RI (US); Keith Thomas Stafford, Princeton, MA (US); Adam Paul Nadeau, Shrewsbury, MA (US); Duan Li Ou, Northboro, MA (US); John Boyle, Cleveland, OH (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 12/044,838

(22) Filed: Mar. 7, 2008

Related U.S. Application Data
(60) Provisional application No. 60/893,558, filed on Mar. 7, 2007.

(51) Int. Cl. B65B 53/02; B29C 70/84; B29C 63/18

(52) U.S. Cl. 428/34.9; 264/271.1; 264/265

(57) ABSTRACT

The disclosure is directed to a method of forming multi-layer tubes including providing a heat-shrinkable fluoropolymer liner and extruding an elastomeric cover over the heat shrinkable fluoropolymer liner. The disclosure is further directed to a method of forming multi-layer tubes including providing a non-fibrillated, high flex fluoropolymer liner and extruding an elastomeric cover over the non-fibrillated, high flex fluoropolymer liner. The disclosure is further directed to the above-mentioned multi-layer tubes.

### CROSS-REFERENCE TO RELATED APPLICATION

The present application claims priority from U.S. Provisional Patent Application No. 60/893,558, filed Mar. 7, 2007, entitled “MULTI-LAYER TUBES,” naming inventors Mark W. Simon, Keith T. Stafford, Adam P. Nadeau, Duan L. Ou, and John Boyle, which application is incorporated by reference herein in its entirety.

### FIELD OF THE DISCLOSURE

This disclosure, in general, relates to multi-layer tubes and methods for making such tubes.

### BACKGROUND

Peristaltic pumps include a series of rollers and fixed pump housings. The peristaltic pump moves substances, typically in liquid form, by squeezing the peristaltic pump tube. Increasingly, peristaltic pumps are being used for high purity applications or for the transport of aggressive chemicals. Accordingly, the tubes are generally manufactured from polymers that are both resistant to chemical damage and can withstand the physical demands of the peristaltic pump.

Low surface energy polymers, such as fluoropolymers, exhibit a resistance to damage caused by exposure to chemicals, have a resistance to stains, demonstrate a resistance to damage caused by exposure to environmental conditions, and typically, form a release surface. While such low surface energy polymers are in demand, the polymers tend to be expensive and tend not to have the flexure desired for peristaltic pump applications. Hence, fluoropolymers generally cannot withstand repeated and long-term use. In addition, such polymers exhibit low wetting characteristics and given their tendency to form a release surface, adhere poorly with other polymer substrates.

For particular peristaltic pump applications, manufacturers have turned to producing multi-layer fluoropolymer tubes. For example, Zumbrum (U.S. Publication No. 2006/0018777) describes a fluoroplastic composite lined elastomeric tube. Specifically, the inner liner is a composite of an expanded polytetrafluoroethylene (PTFE) and a fluoroplastic polymer. As stated in Zumbrum, expanded PTFE has a porous node and fibril structure. To produce the tube, a thin film of the composite is repeatedly wrapped on a mandrel. Once wrapped, the layers of the film are heated to form the liner. Subsequently, the liner is etched and the liner is covered with a length of elastomeric tubing. The elastomeric tubing is then wrapped with nylon cure wrap and the mandrel is heated. Unfortunately, this process to produce the tubing is both lengthy and expensive and typically the length of a tube that may be economically formed by such a process is limited.

Hence, it would be desirable to provide both an improved multi-layer tube as well as a method for manufacturing such multi-layer tubes.

### SUMMARY

In a particular embodiment, a method of forming a multi-layer tube includes providing a heat-shrinkable fluoropolymer liner and extruding an elastomeric cover over a heat shrinkable fluoropolymer liner.

In another exemplary embodiment, a tube includes a first layer comprising heat-shrinkable polytetrafluoroethylene and a second layer adjacent the first layer. The second layer includes an elastomer.

In a further exemplary embodiment, a tube includes a liner comprising a paste-extruded polytetrafluoroethylene layer and a cover overlying the liner. The cover includes an elastomer.

In an exemplary embodiment, a method of forming a multi-layer tube includes providing a non-fibrillated, high flex fluoropolymer liner and extruding an elastomeric cover over the non-fibrillated, high flex fluoropolymer liner.

In a further exemplary embodiment, a tube includes a first layer comprising non-fibrillated, high flex fluoropolymer and a second layer adjacent the first layer. The second layer includes an elastomer.

### BRIEF DESCRIPTION OF THE DRAWINGS

The present disclosure may be better understood, and its numerous features and advantages made apparent to those skilled in the art by referencing the accompanying drawings.

FIGS. 1 and 2 include illustrations of exemplary multi-layer tubes.

FIGS. 3, 4, 5, 6, 7, 8, 9, 10, 11,12, 13, and 14 include graphical illustrations of data representing the performance of exemplary multi-layer tubes.

### DESCRIPTION OF THE DRAWINGS

In a particular embodiment, a multi-layer tube includes a liner and a cover. The liner includes a low surface energy polymer. For example, the low surface energy polymer may include a fluoropolymer. The cover includes an elastomer and directly contacts the liner. In an exemplary embodiment, the multi-layer tube may also include an intermediate layer sandwiched between the liner and the cover. The intermediate layer may include, for example, an adhesive layer.

In an example, the liner includes a low surface energy polymer, such as a fluoropolymer. An exemplary fluoropolymer may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. For example, the fluoropolymer is polytetrafluoroethylene (PTFE). In an embodiment, the PTFE is non-fibrillated. “Non-fibrillated” as used herein refers to a structure that does not contain fibrils. In an exemplary embodiment, the fluoropolymer is a heat-shrinkable polytetrafluoroethylene (PTFE). The heat-shrinkable PTFE of the disclosure has a stretch ratio, defined as the ratio of the stretched dimension to the unstretched dimension, of not greater than about 4:1, such as not greater than about 3:1, not greater than about 2.5:1, or not greater than about 2:1. In an example, the heat-shrinkable PTFE may be uniaxially stretched. Alternatively, the heat-shrinkable PTFE may be biaxially stretched. In particular, the stretch ratio may be between about 1.5:1 and about 2.5:1. In an exemplary embodiment, the heat-shrinkable PTFE is not stretched to a node and fibril structure. In contrast, expanded PTFE is generally biaxially expanded at ratios of about 4:1 to form node and fibril structures. Hence, the heat-shrinkable PTFE of the disclosure maintains chemical resistance as well as achieves flexibility. In an embodiment, the heat-shrinkable PTFE has a tensile modulus at 100% elongation of less than about 3000 psi, such as less than about 2500 psi, or less than about 2000 psi.

In an embodiment, the fluoropolymer has high flex. High flex PTFE, such as Zeus' high flex PTFE product, maintains flexure as well as maintains chemical resistance. Further, high flex PTFE is not stretched to a node and fibril structure. Using M.I.T. folding/flex endurance, a high flex PTFE typically has a flex cycle greater than 3.0 million cycles, such as greater than 4.0 million cycles, such as greater than 5.0 million cycles, such as greater than 6.0 million cycles, or even greater than 6.5 million cycles when tested with a load of 4.5 lbs. Heat-shrinkable PTFE has a flex cycle greater than 3.0 million cycles, such as greater than 4.0 million cycles, such as greater than 5.0 million cycles, or even greater than 5.5 million cycles when tested with a load of 4.5 lbs. In contrast, the standard PTFE such as Zeus' standard PTFE product has a flex cycle of less than about 2.5 million cycles when tested with a load of 4.0 lbs. Further, heat-shrinkable PTFE with a stretch ratio of about 4:1 has a flex cycle of less than about 2.0 million cycles when tested with a load of 4.5 lbs.

Further, exemplary fluoropolymers include a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), poly vinylidene fluoride (PVDF), a terpolymer including tetrafluoroethylene, hexafluoropropylene, and vinylidenefluoride (THV), or any blend or any alloy thereof. For example, the fluoropolymer may include FEP. In a further example, the fluoropolymer may include PVDF. In an exemplary embodiment, the fluoropolymer may be a polymer crosslinkable through radiation, such as e-beam. An exemplary crosslinkable fluoropolymer may include ETFE, THV, PVDF, or any combination thereof. A THV resin is available from Dyneon 3M Corporation Minneapolis, Minn. An ECTFE polymer is available from Ausimont Corporation (Italy) under the trade name Halar. Other fluoropolymers used herein may be obtained from Daikin (Japan) and DuPont (USA). In particular, FEP fluoropolymers are commercially available from Daikin, such as NP-12X.

In an embodiment, the fluoropolymer liners are paste extruded as opposed to mandrel wrapped. Paste extrusion is a process that typically includes extruding a paste of a lubricant and a fluoropolymer powder. In an example, the fluoropolymer powder is a fine PTFE powder fibrillated by application of shearing forces. This paste is extruded at low temperature (e.g., not exceeding 75° C.). In an embodiment, the paste is extruded in the form of a tube to form the liner. Once the paste is extruded, the PTFE may be stretched to a ratio of less than about 4:1 to form heat shrinkable PTFE. In particular, the heat-shrinkable PTFE may be uniaxially stretched by inflating the paste-extruded tube.

In contrast, expanded PTFE is typically formed on a mandrel. Typically, sheets of PTFE are expanded, such as biaxially stretching, and then wrapped around the mandrel. Due to the node and fibril structure of expanded PTFE, fluoroplastic sheets may be alternated and wrapped with the sheets of expanded PTFE. Subsequently, the mandrel is heated to a temperature sufficient to bond the multiple layers together and produce an expanded PTFE liner.

In an example, the heat-shrinkable PTFE liners have advantageous physical properties, such as desirable elongation-at-break. Elongation-at-break of the liner is the measure of elongation until the liner fails (i.e., breaks). In an exemplary embodiment, the liner may exhibit an elongation-at-break based on a modified ASTM D638 Type 5 specimen testing methods of at least about 250%, such as at least about 300%, or at least about 400%.

In an exemplary embodiment, the cover may be formed of an elastomeric material. An exemplary elastomer may include cross-linkable elastomeric polymers of natural or synthetic origin. For example, an exemplary elastomeric material may include silicone, natural rubber, urethane, olefinic elastomer, diene elastomer, blend of olefinic and diene elastomer, fluoroelastomer, perfluoroelastomer, or any combination thereof.

In an exemplary embodiment, the elastomeric material is a silicone formulation. The silicone formulation may be formed, for example, using a non-polar silicone polymer. In an example, the silicone polymer may include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In general, the silicone polymer is non-polar and is free of halide functional groups, such as chlorine and fluorine, and of phenyl functional groups. Alternatively, the silicone polymer may include halide functional groups or phenyl functional groups. For example, the silicone polymer may include fluorosilicone or phenylsilicone.

In an embodiment, the silicone polymer is a platinum catalyzed silicone formulation. Alternatively, the silicone polymer may be a peroxide catalyzed silicone formulation. The silicone polymer may be a liquid silicone rubber (LSR) or a high consistency gum rubber (HCR). In a particular embodiment, the silicone polymer is a platinum catalyzed LSR. In a further embodiment, the silicone polymer is an LSR formed from a two part reactive system. Particular embodiments of LSR include Wacker 3003 by Wacker Silicone of Adrian, Mich. and Rhodia 4360 by Rhodia Silicones of Ventura, Calif. In another example, the silicone polymer is an HCR, such as GE 94506 HCR available from GE Plastics.

In an embodiment, self-bonding silicone polymers may be used. Self-bonding silicone polymers typically have improved adhesion to substrates compared to conventional silicones. Particular embodiments of self-bonding silicone polymers include GE LIMS 8040 available from GE Plastics and KE2090-40 available from Shin-Etsu.

When the cover is a silicone formulation, the shore A durometer (Shore A) of the silicone polymer cover may be less than about 75, such as about 20 to about 50, such as about 30 to about 50, or about 40 to about 50.

In another embodiment, the elastomeric material includes a crosslinkable elastomeric polymer. For example, the elastomeric cover may include a diene elastomer. In a particular example, the elastomeric material may include a blend of a diene elastomer and a polyolefin. The diene elastomer may be a copolymer formed from at least one diene monomer. For example, the diene elastomer may be a copolymer of ethylene, propylene and diene monomer (EPDM). An exemplary diene monomer may include a conjugated diene, such as butadiene, isoprene, chloroprene, or the like; a non-conjugated diene including from 5 to about 25 carbon atoms, such as 1,4-pentadiene, 1,4-hexadiene, 1,5-hexadiene, 2,5-dimethyl-1,5-hexadiene, 1,4-octadiene, or the like; a cyclic diene, such as cyclopentadiene, cyclohexadiene, cyclooctadiene, dicyclopentadiene, or the like; a vinyl cyclic ene, such as 1-vinyl-1-cyclopentene, 1-vinyl-1-cyclohexene, or the like; an alkylbicyclononadiene, such as 3-methylbicyclo-(4,2,1)-nona-3,7-diene, or the like; an indene, such as methyl tetrahydroindene, or the like; an alkenyl norbornene, such as 5-ethylidene-2-norbornene, 5-butylidene-2-norbornene, 2-methallyl-5-norbornene, 2-isopropenyl-5-norbornene, 5-(1,5-hexadienyl)-2-norbornene, 5-(3,7-octadienyl)-2-norbornene, or the like; a tricyclodiene, such as 3-methyltricyclo (5,2,1,0²,6)-deca-3,8-diene or the like; or any combination thereof. In a particular embodiment, the diene includes a non-conjugated diene. In another embodiment, the diene elastomer includes alkenyl norborene. The diene elastomer may include, for example, ethylene from about 63.0 wt % to about 95.0 wt % of the polymer, propylene from about 5.0 wt % to about 37.0 wt %, and the diene monomer from about 0.2 wt % to about 15.0 wt %, based upon the total weight of the diene elastomer. In a particular example, the ethylene content is from about 70.0 wt % to about 90.0 wt %, propylene from about 17.0 wt % to about 31.0 wt %, and the diene monomer from about 2.0 wt % to about 10.0 wt % of the diene elastomer. Prior to crosslinking, the diene elastomer may have a green tensile strength of about 800 psi to about 1,800 psi, such as about 900 psi to about 1,600 psi. The uncrosslinked diene elastomer may have an elongation-at-break of at least about 600 percent. In general, the diene elastomer includes a small amount of a diene monomer, such as a dicyclopentadiene, a ethylnorbornene, a methylnorbornene, a non-conjugated hexadiene, or the like, and typically have a number average molecular weight of from about 50,000 to about 100,000. Exemplary diene elastomers are commercially available under the tradename Nordel from Dow Dupont.

The polyolefin of the blend may include a homopolymer, a copolymer, a terpolymer, an alloy, or any combination thereof formed from a monomer, such as ethylene, propylene, butene, pentene, methyl pentene, octene, or any combination thereof. An exemplary polyolefin includes high density polyethylene (HDPE), medium density polyethylene (MDPE), low density polyethylene (LDPE), ultra low density polyethylene, ethylene propylene copolymer, ethylene butene copolymer, polypropylene (PP), polybutene, polypentene, polymethylpentene, polystyrene, ethylene propylene rubber (EPR), ethylene octene copolymer, or any combination thereof. In a particular example, the polyolefin includes high density polyethylene. In another example, the polyolefin includes polypropylene. In a further example, the polyolefin includes ethylene octene copolymer. In a particular embodiment, the polyolefin is not a modified polyolefin, such as a carboxylic functional group modified polyolefin, and in particular, is not ethylene vinyl acetate. In addition, the polyolefin is not formed from a diene monomer. In a particular example, the polyolefin has a degree of crystallinity. For example, the polyolefin may have at least about 35% crystallinity. In a particular example, the polyolefin may have a crystallinity of at least about 50%, such as at least about 60% or at least about 70% crystallinity. In a particular example, the polyolefin may be a high crystallinity polyolefin. Alternatively, the polyolefin may be a low crystallinity polyolefin, having a crystallinity not greater than 35%. Low crystallinity polyolefins may improve clarity in particular applications. An exemplary commercially available polyolefin includes Equistar 8540, an ethylene octene copolymer; Equistar GA-502-024, an LLDPE; Dow DMDA-8904NT 7, an HDPE; Basell Pro-Fax SR275M, a random polypropylene copolymer; Dow 7C50, a block PP copolymer; or products formerly sold under the tradename Engage by Dupont Dow.

In an example, the blend includes not greater than about 40.0 wt % polyolefin, such as not greater than about 30.0 wt % polyolefin. For example, the blends may include not greater than about 20.0 wt % of the polyolefin, such as not greater than 10.0 wt %. In a particular example, the blend includes about 5.0 wt % to about 30.0 wt %, such as about 10.0 wt % to about 30.0 wt %, about 10.0 wt % to about 25.0 wt %, or about 10.0 wt % to about 20.0 wt %. An exemplary commercial EPDM/polyolefin blend includes Santoprene 8291 available from Advanced Elastomer Systems.

In general, the blend exhibits compatibility between the polymeric components. DMA analysis may provide evidence of compatibility. DMA analysis may show a single tan delta peak between glass transition temperatures of major components of a blend, indicating compatibility. Alternatively, an incompatible blend may exhibit more than one tan delta peak. In an example, the blend may exhibit a single tan delta peak. In particular, the single tan delta peak may be between the glass transition temperature of the polyolefin and the glass transition temperature of the diene elastomer.

In an exemplary embodiment, the blend may be cured through cross-linking. In a particular example, the diene elastomer may be cross-linkable through radiation, such as using X-ray radiation, gamma radiation, ultraviolet electromagnetic radiation, visible light radiation, electron beam (e-beam) radiation, or any combination thereof. Ultraviolet (UV) radiation may include radiation at a wavelength or a plurality of wavelengths in the range of from 170 nm to 400 nm, such as in the range of 170 nm to 220 nm. Ionizing radiation includes high-energy radiation capable of generating ions and includes electron beam (e-beam) radiation, gamma radiation, and x-ray radiation. In a particular example, e-beam ionizing radiation includes an electron beam generated by a Van de Graaff generator, an electron-accelerator, or an x-ray. In an alternative embodiment, the diene elastomer may be crosslinkable through thermal methods. In a further example, the diene elastomer may be crosslinkable through chemical reaction, such as a reaction between a silane crosslinking agent and water.

In an exemplary embodiment, the blend may further include a crosslinking agent, a photoinitiator, a filler, a plasticizer, or any combination thereof. Alternatively, the blend may be free of crosslinking agents, photoinitiators, fillers, or plasticizers. In particular, the blend may be free of photoinitiators or crosslinking agents.

To facilitate crosslinking, the blend may include a photoinitiator or a sensibilizer composition. For example, when ultra-violet radiation is contemplated as the form of irradiation or when e-beam radiation is contemplated as the form of irradiation, the material may include a photoinitiator to increase the crosslinking efficiency, i.e., degree of crosslinking per unit dose of radiation.

An exemplary photoinitiator includes benzophenone, ortho- and para-methoxybenzophenone, dimethylbenzophenone, dimethoxybenzophenone, diphenoxybenzophenone, acetophenone, o-methoxy-acetophenone, acenaphthene-quinone, methyl ethyl ketone, valerophenone, hexanophenone, alpha-phenyl-butyrophenone, p-morpholinopropiophenone, dibenzosuberone, 4-morpholinobenzo-phenone, benzoin, benzoin methyl ether, 3-o-morpholinodeoxybenzoin, p-diacetyl-benzene, 4-aminobenzophenone, 4′-methoxyacetophenone, alpha-tetralone, 9-acetylphenanthrene, 2-acetyl-phenanthrene, 10-thioxanthenone, 3-acetyl-phenanthrene, 3-acetylindole, 9-fluorenone, 1-indanone, 1,3,5-triacetylbenzene, thioxanthen-9-one, xanthene-9-one, 7-H-benz[de]anthracen-7-one, benzoin tetrahydrophyranyl ether, 4,4′-bis(dimethylamino)-benzophenone, 1′-acetonaphthone, 2′ acetonaphthone, aceto-naphthone and 2,3-butanedione, benz[a]anthracene-7,12-dione, 2,2-dimethoxy-2-phenylaceto-phenone, alpha-diethoxy-acetophenone, alpha-dibutoxy-acetophenone, anthraquinone, isopropylthioxanthone, or any combination thereof. An exemplary polymeric initiator may include poly(ethylene/carbon monoxide), oligo[2-hydroxy-2-methyl-1-[4-(1-methylvinyl)-phenyl]propanone], polymethylvinyl ketone, polyvinylaryl ketones, or any combination thereof.

Another exemplary photoinitiator includes benzophenone; anthrone; xanthone; the Irgacure® series of photoinitiators from Ciba-Geigy Corp. including 2,2-dimethoxy-2-phenylacetophenone (Irgacure® 651), 1-hydroxycyclohexylphenyl ketone (Irgacure® 184), or 2-methyl-1-[4-(methylthio)phenyl]-2-moropholino propan-1-one (Irgacure® 907); or any combination thereof. Generally, the photoinitiator exhibits low migration from the material of the elastomeric cover. In addition, the photoinitiator typically has a low vapor pressure at extrusion temperatures and sufficient solubility in the polymer or polymer blends of the elastomeric cover to yield efficient crosslinking. In an exemplary embodiment, the vapor pressure and solubility, or polymer compatibility, of the photoinitiator may be improved by derivatizing the photoinitiator. An exemplary derivatized photoinitiator includes, for example, higher molecular weight derivatives of benzophenone, such as 4-phenylbenzophenone, 4-allyloxybenzophenone, 4-dodecyloxybenzophenone, or any combination thereof. In an example, the photoinitiator may be covalently bonded to a polymer of the material of the elastomeric cover.

In an exemplary embodiment, the blend includes about 0.0 wt % to about 3.0 wt % photoinitiator, such as about 0.1 wt % to about 2.0 wt %.

Crosslinking of the blend may also be facilitated by a chemical crosslinking agent, such as a peroxide, an amine, a silane, or any combination thereof. In an exemplary embodiment, the blend may be prepared by dry blending solid state forms of polymer and the crosslinking agent, i.e., in powder form. Alternatively, the material may be prepared in liquid form, sorbed in inert powdered support or by preparing coated pellets, or the like.

An exemplary thermally activatable crosslinking agent includes a free radical generating chemical, which when exposed to heat decomposes to form at least one, and typically two or more free radicals to effect crosslinking. In an exemplary embodiment, the crosslinking agent is an organic crosslinking agent including an organic peroxide, an amine, a silane, or any combination thereof.

An exemplary organic peroxide includes 2,7-dimethyl-2,7-di(t-butylperoxy)octadiyne-3,5; 2,7-dimethyl-2,7-di(peroxy ethyl carbonate)octadiyne-3,5; 3,6-dimethyl-3,6-di(peroxy ethyl carbonate)octyne-4; 3,6-dimethyl-3,6-(t-butylperoxy)octyne-4; 2,5-dimethyl-2,5-di(peroxybenzoate)hexyne-3; 2,5-dimethyl-2,5-di(peroxy-n-propyl carbonate)hexyne-3; 2,5-dimethyl-2,5-di(peroxy isobutyl carbonate)hexyne-3; 2,5-dimethyl-2,5-di(peroxy ethyl carbonate)hexyne-3; 2,5-dimethyl-2,5-di(alpha-cumyl peroxy)hexyne-3; 2,5-dimethyl-2,5-di(peroxy beta-chloroethyl carbonate) hexyne-3; 2,5-dimethyl-2,5-di(t-butylperoxy) hexyne-3; or any combination thereof. A particular crosslinking agent is 2,5-dimethyl-2,5-di(t-butyl peroxy)hexyne-3, available from Elf Atochem under the trade designation Lupersol 130. Another exemplary crosslinking agent is dicumyl peroxide, available from Elf Atochem as Luperox 500R. In a particular embodiment, the crosslinking agent is present in the material in an amount between about 0.1 wt % to about 5.0 wt %, such as about 0.5 wt % to about 2.0 wt % based on the weight of the material.

In another exemplary embodiment, an amine crosslinking agent may include a monoalkyl, duallyl or trialkyl monoamine, wherein the alkyl group contains from about 2 to about 14 carbon atoms; a trialkylene diamine of the formula N(R²)₃N; a dialkylene diamine of the formula HN(R²)₂NH; an alkylene diamine, H₂NR²NH₂; a dialkylene triamine, H₂NR²NHR²NH₂; an aliphatic amine having a cyclic chain of from four to six carbon atoms; or any combination thereof. The alkylene group R² in the above formulae may include from about 2 to about 14 carbon atoms. An exemplary cyclic amine may have a heteroatom, such as oxygen, for example, an N-alkyl morpholine. Another exemplary cyclic amine includes pyridine, N,N-dialkyl cyclohexylamine, or any combination thereof. An exemplary amine is triethylamine; di-n-propylamine; tri-n-propylamine; n-butylamine; cyclohexylamine; triethylenediamine; ethylenediamine; propylenediamine; hexamethylenediamine; N,N-diethyl cyclohexylamine; pyridine; ethyl-p-dimethyl amine benzoate (EDAB); octyl-p-dimethyl aminobenzoate (ODAB); or any combination thereof. In an exemplary embodiment, the material includes from about 0.5 wt % to about 10.0 wt % of the amine.

An exemplary silane crosslinking agent has the general formula:

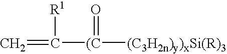

in which R¹ is a hydrogen atom or methyl group; x and y are 0 or 1 with the proviso that when x is 1, y is 1; n is an integer from 1 to 12, preferably 1 to 4, and each R independently is a hydrolyzable organic group such as an alkoxy group having from 1 to 12 carbon atoms (e.g., methoxy, ethoxy, butoxy), aryloxy group (e.g., phenoxy), araloxy group (e.g., benzyloxy), aliphatic acyloxy group having from 1 to 12 carbon atoms (e.g., formyloxy, acetyloxy, propanoyloxy), amino or substituted amino groups (e.g., alkylamino, arylamino), or a lower alkyl group having 1 to 6 carbon atoms, with the proviso that not more than one of the three R groups is an alkyl. Such silanes may be grafted to a polymer through the use of an organic peroxide. Additional ingredients such as heat and light stabilizers, pigments, or any combination thereof, also may be included in the material. In general, the crosslinking reaction may result from a reaction between the grafted silane groups and water. Water may permeate into the bulk polymer from the atmosphere or from a water bath or “sauna”. An exemplary silane includes an unsaturated silane that comprise an ethylenically unsaturated hydrocarbyl group, such as a vinyl, allyl, isopropenyl, butenyl, cyclohexenyl or gamma-(meth)acryloxy allyl group, and a hydrolyzable group, such as, for example, a hydrocarbyloxy, hydrocarbonyloxy, or hydrocarbylamino group. An example of a hydrolyzable group includes a methoxy group, an ethoxy group, a formyloxy group, an acetoxy group, a proprionyloxy group, an alkyl group, an arylamino group, or any combination thereof. A particular silane is an unsaturated alkoxy silanes that can be grafted onto the polymer. In particular, the silane may include vinyl trimethoxy silane, vinyl triethoxy silane, gamma-(meth)acryloxy propyl trimethoxy silane, or any combination thereof.

The amount of silane crosslinker may vary widely depending upon the nature of the blend, the silane, the processing conditions, the grafting efficiency, the ultimate application, and similar factors. Typically, at least 0.5 parts per hundred resin (phr), such as at least about 0.7 phr, is used. Generally, the amount of silane crosslinker does not exceed 5 phr, such as not greater than about 2 phr.

In a particular example, curing of the blend is enhanced using FirstCure ITX, available from Albemarle, Inc. FirstCure ITX may also be used in conjunction with an amine synergist, such as ethyl-p-dimethyl amine benzoate (EDAB) or octyl-p-dimethyl aminobenzoate (ODAB).

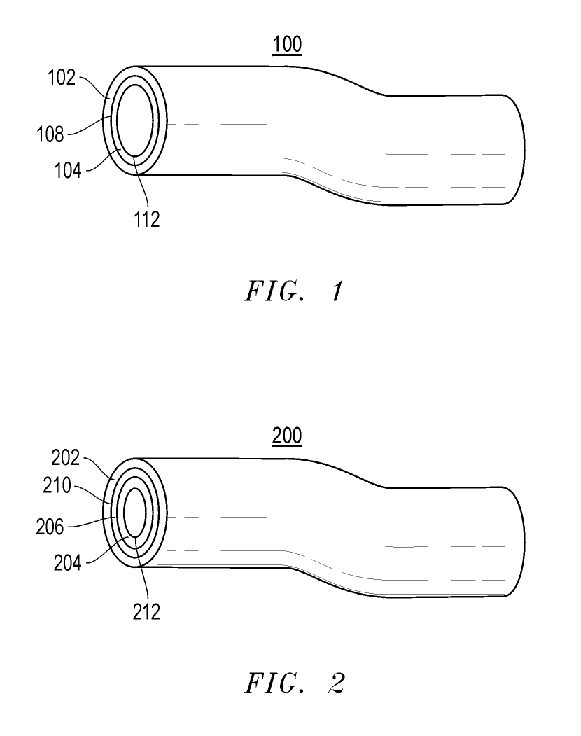

As illustrated in FIG. 1, a multi-layer tube 100 is an elongated annular structure with a hollow central bore. The multi-layer tube 100 includes a cover 102 and a liner 104. The cover 102 may be directly in contact with and may directly bond to a liner 104 along an outer surface 108 of the liner 104. For example, the cover 102 may directly bond to the liner 104 without intervening adhesive layers. In an exemplary embodiment, the multi-layer tube 100 includes two layers, such as the cover 102 and the liner 104.

Alternatively, a multi-layer tube 200 may include two or more layers, such as three layers. For example, FIG. 2 illustrates a third layer 206 sandwiched between liner 204 and cover 202. The liner 204 includes an inner surface 212 that defines a central lumen of the tube. In an exemplary embodiment, third layer 206 is directly in contact with and may be directly bonded to the outer surface 208 of the liner 204. In such an example, the third layer 206 may directly contact and may be directly bonded to cover 202 along an outer surface 210 of third layer 206.

Returning to FIG. 1, the multi-layer tube 100 may be formed through a method wherein the elastomeric cover 102 is extruded over the liner 104. In an embodiment, the elastomeric cover 102 is continuously extruded to a length of at least about 25 feet. In an exemplary embodiment, the elastomeric cover 102 is continuously extruded to a length of about 25 feet to about 500 feet. In an embodiment, the elastomeric cover 102 is extruded without the use of a mandrel. The liner includes an inner surface 112 that defines a central lumen of the tube. In an exemplary embodiment, the liner may be a paste-extruded fluoropolymer.

Prior to extrusion of the cover 102, adhesion between the liner 104 and the cover 102 may be improved through the use of a surface treatment of the outer surface 108 of the liner 104. A surface treatment may include chemical etch, physical-mechanical etch, plasma etch, corona treatment, chemical vapor deposition, or any combinations thereof. In an embodiment, the chemical etch includes sodium ammonia and sodium naphthalene. Physical-mechanical etch may include sandblasting and air abrasion. In another embodiment, plasma etching includes reactive plasmas such as hydrogen, oxygen, acetylene, methane, and mixtures thereof with nitrogen, argon, and helium. Corona treatment may include the reactive hydrocarbon vapors, such as acetone. In an embodiment, the chemical vapor deposition includes the use of acrylates, vinylidene chloride, or acetone. In an embodiment, the adhesion between the liner 104 and the cover 102 may be improved through the use of a self-bonding elastomeric material for the cover 102. Alternatively, the adhesion between the liner 104 and the cover 102 may be improved through the use of an adhesive layer.

Once the multi-layer tube is formed, the multi-layer tube may be subjected to a thermal treatment. Thermal treatment typically occurs at a temperature of about 125° C. to about 200° C. In an embodiment, the thermal treatment is at a temperature of about 150° C. to about 180° C. Typically, the thermal treatment occurs for a time period of about 5 minutes to about 10 hours, such as about 10 minutes to about 30 minutes, or alternatively about 1 hour to about 4 hours.

In general, the cover 102 has greater thickness than the liner 104. The total tube thickness of the multi-layer tube 100 may be at least about 3 mils to about 50 mils, such as about 3 mils to about 20 mils, or about 3 mils to about 10 mils. In an embodiment, the liner 104 has a thickness of about 1 mil to about 20 mils, such as about 3 mils to about 10 mils, or about 1 mil to about 2 mils.

In an embodiment, radiation crosslinking may be performed once the multi-layer tube is formed. The radiation may be effective to crosslink the elastomer of the cover. The intralayer crosslinking of polymer molecules within the cover provides a cured composition and imparts structural strength to the cover of the multi-layer tube. In addition, radiation may effect a bond between cover and the liner, such as through interlayer crosslinking. In a particular embodiment, the combination of interlayer crosslinking bonds between the liner and the cover present an integrated composite that is highly resistant to delamination, has a high quality of adhesion resistant and protective surface, incorporates a minimum amount of adhesion resistant material, and yet, is physically substantial for convenient handling and deployment of the multi-layer tube.

In a particular embodiment, the radiation may be ultraviolet electromagnetic radiation having a wavelength between 170 nm and 400 nm, such as about 170 nm to about 220 nm. Crosslinking may be effected using at least about 120 J/cm² radiation.

Once formed and cured, particular embodiments of the above-disclosed multi-layer tube advantageously exhibit desired properties such as chemical stability, flow stability, and increased lifetime. For example, the multi-layer tube may have a pump life of greater than about 200 hours. In an embodiment, a multi-layer tube including a cover formed of a silicon rubber is particularly advantageous, providing desirable lifetime and chemical resistance properties. In another embodiment, a multi-layer tube including a cover formed of a blend of EPDM and polyolefin is particularly advantageous, also providing a desirable lifetime. Further, a multi-layer tube including a liner formed of a heat-shrinkable fluoropolymer is particularly advantageous, providing lifetime and low permeability properties over other fluoropolymers. In a further embodiment, a liner formed of a sodium-ammonia etched heat-shrinkable fluoropolymer is desirable, or alternatively, a liner formed of a sodium-naphthalene etched heat-shrinkable fluoropolymer may provide desirable lifetime.

In an exemplary embodiment, the multi-layer tube may exhibit a peel strength of at least about 0.4 N/mm of width, when tested in standard “T”-Peel configuration at room temperature. In particular, the multi-layer tube may have a peel strength of at least about 0.5 N/mm, such as at least about 0.9 N/mm. In another example, the peel strength of the multi-layer tube may be at least about 1.0 N/mm, such as at least about 1.2 N/mm, or even at least about 1.5 N/mm. When the cover of the multi-layer tube is silicone rubber, the peel strength may be at least about 0.1 N/mm, such as at least about 0.3 N/mm. When the cover of the multi-layer tube is a blend of EPDM and polyolefin, the peel strength may be at least about 0.4 N/mm, such as at least about 0.6 N/mm.

In an exemplary embodiment, the multi-layer tube may have less than about 40% loss in the delivery rate when tested for flow stability. In particular, the multi-layer tube may have less than about 30% loss in the delivery rate. When the cover of the multi-layer tube is silicone rubber, the loss in the delivery rate may be less than about 60%, such as less than about 40%, or even less than about 30%, when tested at 600 rpm on a standard pump head. When the cover of the multi-layer tube is a blend of EPDM and polyolefin, the loss in the delivery rate may be less than about 30%, such as less than about 20%, when tested at 400 rpm on a Masterflex Easy-load II pump head.

### EXAMPLE 1

Four tubes are selected for a performance study. Specifically, a silicone LSR tube is tested with and without a liner to determine life of the tube. The silicone LSR is Wacker product 3003-50 and the three PTFE liners are a standard liner (Zeus product, Teflon Tubing), a high flex liner (Zeus tubing using High Flex Life PTFE resin), and a heat shrink liner (2:1 H/S ratio; obtained from Teleflex). The three liners are chemically etched with sodium-naphthalene and subsequently, the silicone rubber cover is extruded over the liner. The liners have an approximate thickness of 0.008″ to 0.012″ while the jacket has an approximate thickness of 0.052″ to 0.056″.

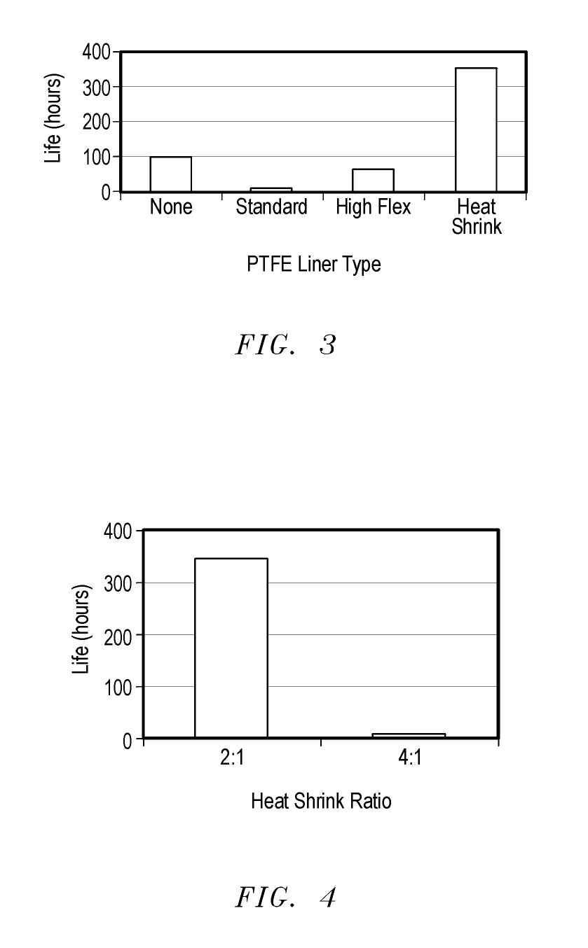

Life of the silicone rubber tubing is tested on either a standard pump head or Easy-load II pump head (Cole Parmer's Masterflex Easy-load II pump head) at 600 rpm. They are tested using water as the transfer liquid with 0 psi of backpressure. FIG. 3 illustrates the affects of the three different liners on the life of the silicone rubber tubing. The heat shrink PTFE liner outperforms the standard and high flex liners by greater than about 5 times. Further, the life of the heat shrink liner improves the life of the silicone rubber tubing compared to the un-lined silicone rubber tubing by greater than about 3 times. Additionally, the heat shrink liner enables containment of fluid even after failure of the silicone rubber cover.

### EXAMPLE 2

Two tubes are selected for a performance study. Specifically, a silicone LSR tube is tested with different heat shrink PTFE liners to determine life of the tube. The silicone rubber cover is Shincore 2090-40 and the two heat shrink liners are commercially available from Teleflex for a liner with a 2:1 ratio and a 4:1 ratio, respectively. The two liners are chemically etched with sodium-naphthalene and subsequently, the silicone rubber cover is extruded over the liner. The liners have an approximate thickness of 0.008″ to 0.012″ while the jacket has an approximate thickness of 0.052″ to about 0.056″. The life of the tubes are tested as described in Example 1.

FIG. 4 illustrates the affects of the two different liners on the life of the silicone rubber tubing. The heat shrink PTFE liner with a 2:1 stretch ratio has an average life of about 350 hours whereas the heat shrink PTFE liner with a 4:1 stretch ratio has an average life of less than about 10 hours. Hence, the pump performance data is consistent with the low flex-fatigue properties of high stretch ratio liners shown by the M.I.T. Folding Endurance data. Tests use an M.I.T. Folding Endurance Tester made by Tinius Olsen Testing Machine Co. The tester folds the sample to an angle of 135 deg in either direction, at the rate of 175 double folds per minute, under a 4.5 lb load until the specimen is severed at the crease. The heat shrink PTFE liner with a 2:1 stretch ratio averages 5.99 million cycles (standard deviation of 0.83) per MIT flex test whereas the heat shrink PTFE liner with a 4:1 stretch ratio averages 1.734 million cycles (standard deviation of 0.572) per MIT flex test. The high flex life PTFE averages 6.891 million cycles (standard deviation of 0.968) per MIT flex test. Standard PTFE tubing averages 2.182 million cycles (standard deviation 0.275) per MIT flex test (under a 4.0 lb load).

### EXAMPLE 3

Two tubes are selected for a performance study of a standard PTFE liner. Specifically, a silicone rubber cover (Wacker product 3003-50) and a Santoprene cover (product 8291-65) are used over a standard PTFE liner (Zeus product, Teflon Tubing) to determine the life of the liner. The silicone rubber cover is extruded over a sodium-naphthalene etched 10 mil standard PTFE liner. The Santoprene cover is continuously extruded over a sodium-naphthalene etched 5 mil standard PTFE liner resulting in a two layer tube. The performance test is performed on an Easy-load II Pump at 150 rpm and 600 rpm.

FIG. 5 illustrates the performance of the standard PTFE liner. Neither tube has a life greater than about 8 hours. Specifically, the liners fail by both cracking and delaminating.

### EXAMPLE 4

Two tubes are selected for a performance study of heat-shrinkable PTFE. Specifically, silicone rubber covers obtained from Wacker (product 3003-50) and Shin Etsu (product 2090-40) are extruded over sodium-naphthalene etched heat-shrinkable PTFE (2:1 H/S ratio; obtained from Teleflex). The tubes are then performance tested on a Masterflex Easy-load II pump at 400 rpm to determine life of the tube. For the silicone rubber covers, a life of greater than 300 hours is achieved. After 300 hours, the test is terminated since no liner failure is detected. Although delamination of the jacket from the liner is observed, the product maintains an appreciable delivery rate.

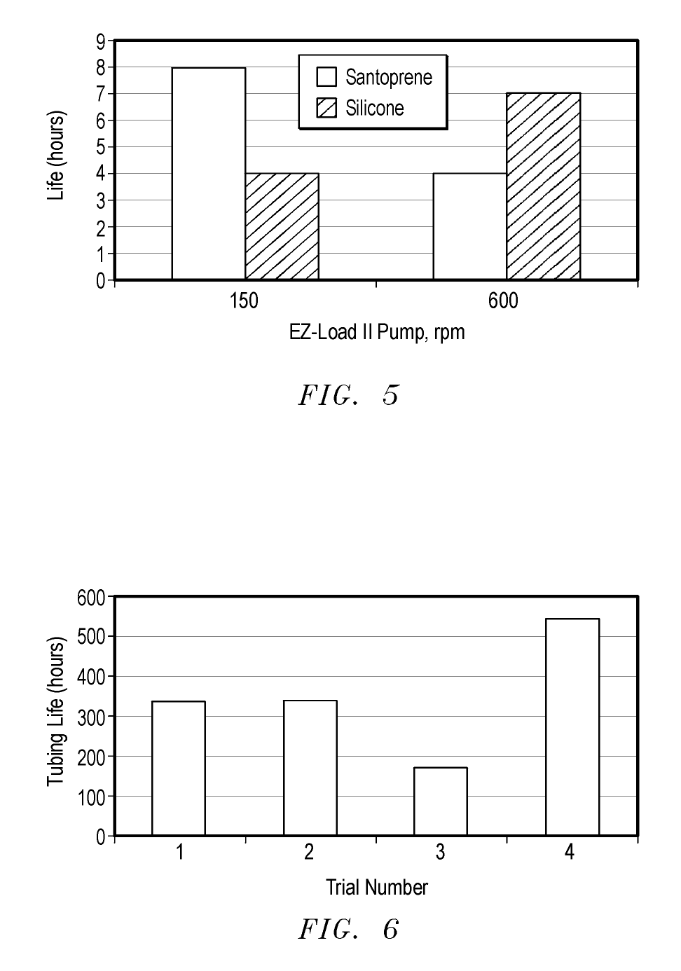

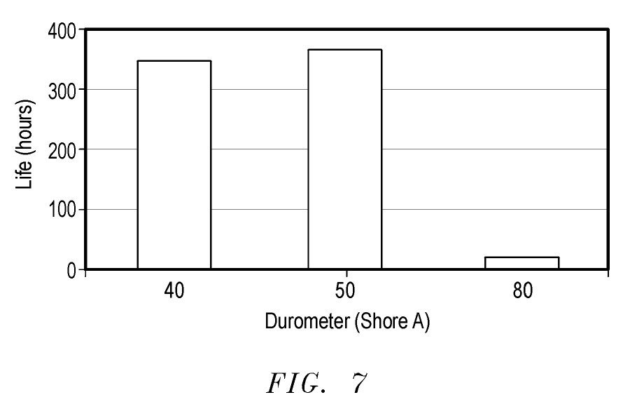

Four test trials at 400 rpm using commercially available Shin Etsu 2090-40 on heat-shrinkable sodium-napthalene etched PTFE are performed. FIG. 6 illustrates the performance of the heat-shrinkable PTFE liner. An average life of 345 hours is achieved. Peel testing is also performed. The tube with Wacker 3003-50 cover has a peel strength of 0.41 N/mm and the tube with the Shin Etsu 2090-40 cover has a peel strength of 0.26 N/mm. The peel test uses an Instron 4465 testing machine which is equipped with a stationary horizontal clamping platform. The horizontal platform is used to clamp the liner in a horizontal position. The jacket material is then clamped into the Instron grip. The grip then transverses in the vertical direction at the rate of two in/min, which pulls the jacket material 90° from the liner surface. The samples have a width of one inch, an approximate liner thickness of 0.008″ to 0.012″ and an approximate jacket thickness of 0.052″ to 0.056″.

### EXAMPLE 5

Four liners are selected for a study of the flexural modulus and elongation. Specifically, liners include commercially available PTFE, such as a standard PTFE from Zeus (Teflon Tubing), a high flex life PTFE (Zeus tubing using High Flex Life resin), a heat-shrink PTFE (2:1 H/S ratio; obtained from Teleflex) and the Teleflex heat-shrink PTFE (heated to a temperature of about 660° F. for a time of about 10 minutes). The liners have a thickness of about 0.010″.

Mechanical properties of the samples are tested such as tensile modulus and the percent elongation at break. The procedure is a modified ASTM D638 procedure using a type 5 shaped specimens. The testing uses an Instron 4465 testing machine equipped with a 5 kN load cell and an extensometer set-up. The test runs with a gage length between extensometer grips of 10 mm and ran at a rate of 100 mm/min.

TABLE 1
Mechanical Properties for PTFE

| | Tensile modulus (psi) | | |
|---|---|---|---|
| | | 100% Elongation | 200% Elongation |
| PTFE liner | | (Std. Dev.) | (Std. Dev.) |

| | | | |
|---|---|---|---|
| Standard | 3431 | (76) | 4470 (122) |
| High Flex Life | 3488 | (104) | 4549 (238) |
| 2:1 Heat-Shrink | 1751 | (188) | 1984 (188) |
| Heat-Shrink (Heated) | 3147 | (83) | 3519 (109) |

A comparative sample including the standard PTFE liner has a tensile modulus of about 5000 psi. Table 1 includes the tensile modulus for the above-described samples. The 2:1 heat-shrink PTFE has greater flex than the standard PTFE and the High Flex Life PTFE. In particular, the 2:1 heat-shrinkable liner is about 2 times more flexible than the standard grade PTFE.

TABLE 2
Mechanical Properties for PTFE

| PTFE liner | Percent Elongation at Break (Std. Dev.) | |
|---|---|---|
| Standard | 241 | (6) |
| High Flex Life | 225 | (8) |
| 2:1 Heat-Shrink | 461 | (16) |
| Heat-Shrink (Heated) | 276 | (10) |

A comparative sample including the standard PTFE liner has an elongation at break of about 240%. Table 2 includes the percent elongation at break for the above-described samples. The 2:1 heat-shrink PTFE has an improved elongation at break over the standard PTFE and the High Flex Life PTFE. In particular, the 2:1 heat-shrinkable liner has greater than about 200% elongation at break than the standard grade PTFE.

### EXAMPLE 6

Three tubes are selected for a performance study of the durometer of the silicone rubber. Three different self-bonding LSR formulations are used as covers over a sodium-naphthalene etched heat-shrink PTFE (2:1 H/S ratio; obtained from Teleflex). The three LSR formulations have a Durometer of 40, 50, and 80 (Shore A) and each contains a vinyl-containing silsesquioxane which is used as an adhesion promoter. The vinyl-containing silsesquioxane is VEE-005 obtained from Gelest. The life of the tubes are tested as described in Example 3.

FIG. 7 illustrates the affects of the cover durometer on the life of the multi-layer tube. The life of the 40-Durometer and 50-Durometer silicone formulations are comparable with the 50-Durometer sample exhibiting a higher life. The life of the multi-layer tube drops drastically with the 80-Durometer cover.

### EXAMPLE 7

Two tubes are selected for a performance study of treatment time and temperature on etched liners. Specifically, a Santoprene cover (product 8291-65) is used over a PTFE liner (Zeus High Flex Life) and the tube is heated at varying times and varying temperatures to determine optimal adhesion and increase the life of the tubes. The Santoprene cover is continuously extruded over the PTFE liner which is etched with either sodium-ammonia or sodium-naphthalene. The performance test is performed on a Masterflex Easy-Load II Pump at 400 rpm.

FIG. 8 illustrates the performance of the tube with varying process temperatures for a heating time of 10 minutes at each temperature. The sodium-ammonia etch and process temperature of 175° C. is optimum. Softening of the Santoprene cover is at 154° C. At temperatures greater than 200° C. the Santoprene cover begins to melt.

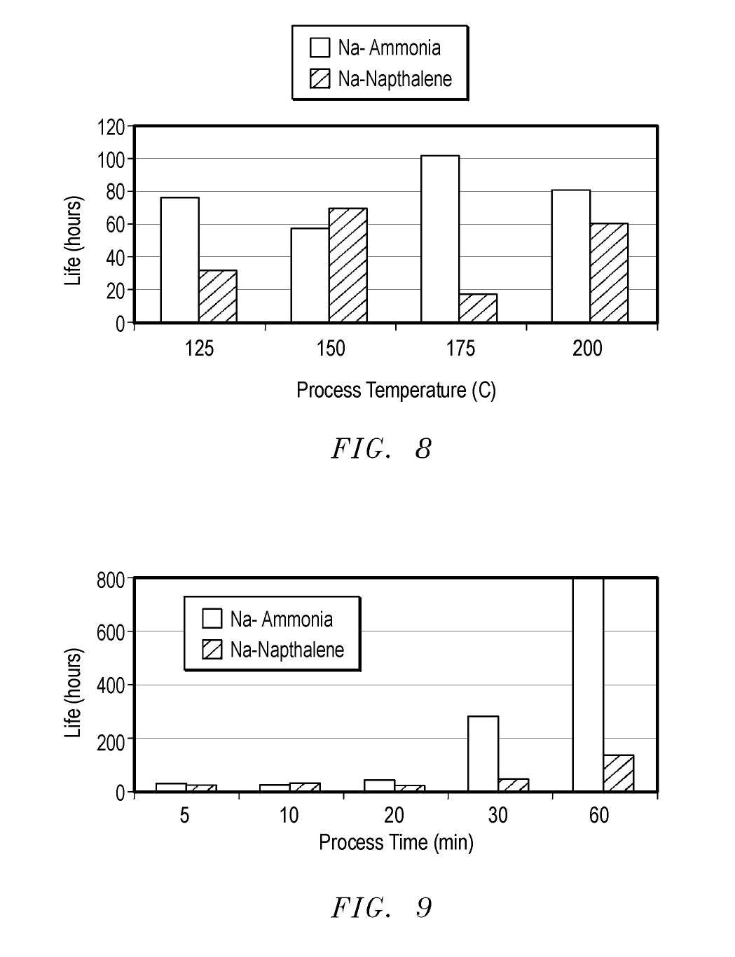

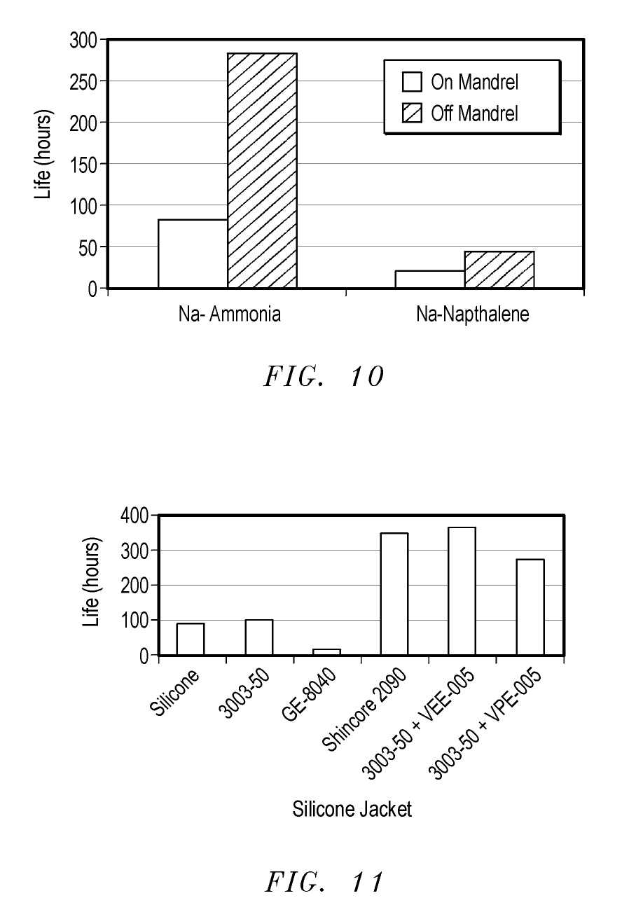

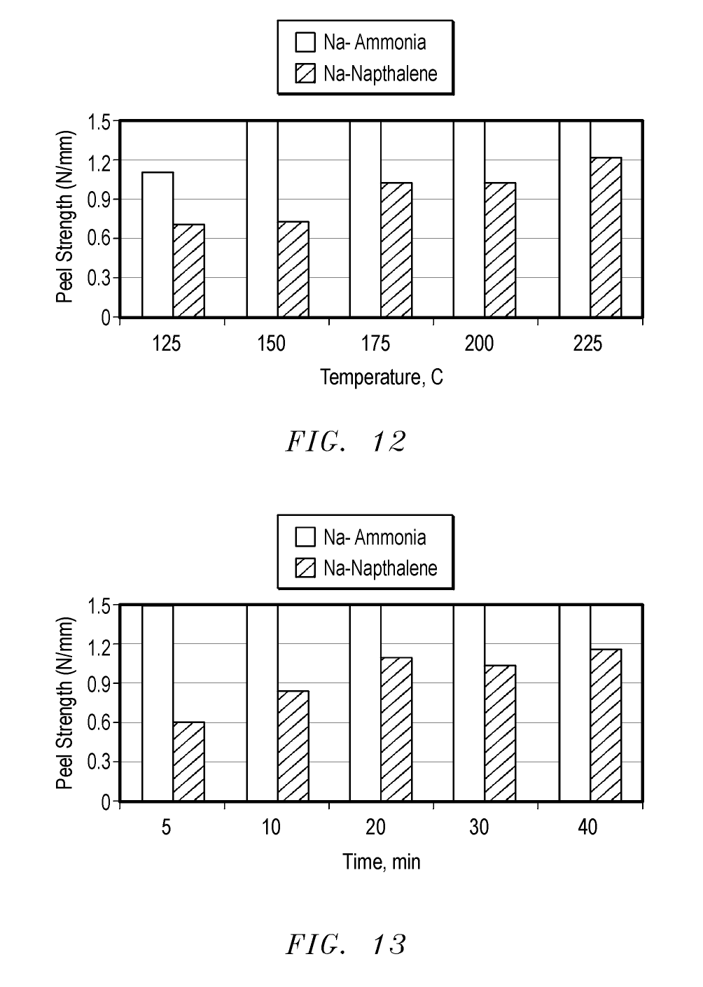

FIG. 9 illustrates the performance of the tube with varying process times at a heating temperature of 175° C. The sodium-ammonia etch and process time of 60 minutes is optimum. At processing times greater than 60 minutes the Santoprene cover begins to degrade and discolor.

### EXAMPLE 8

Two tubes are selected for a performance study of the tube on and off a mandrel. Specifically, a Santoprene cover (product 8291-65) is used over a PTFE liner (Zeus High Flex Life) and the tube is heated on an off a mandrel at a temperature of 175° C. for 30 minutes to determine the life of the tubes. The Santoprene cover is continuously extruded over the PTFE liner which is etched with either sodium-ammonia or sodium-naphthalene. In this example, 150 feet of uninterrupted product length is produced. In order to make a continuous length of tubing and avoid use of a mandrel, air pressure was used to maintain ID geometry and provide support during extrusion jacketing. The performance test is performed on a Masterflex Easy-Load II Pump at 400 rpm.

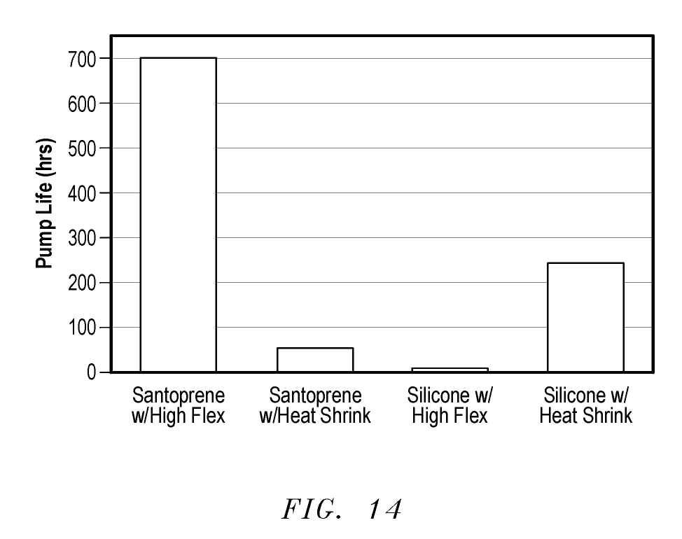

FIG. 10 illustrates the performance of the tube on and off the mandrel. The tubes heated on the mandrel had a lower life than the tubes heated off the mandrel. In an embodiment, thermal treatment of the multi-layer tube on a mandrel decreases the life of the tube. Hence, the performance of the multi-layer tube may be adversely affected with the use of a mandrel. As such, the use of a mandrel is generally not desirable for producing the multi-layer tube, and in particular, the mandrel is not desirable for producing the heat-shrink PTFE liner.

### EXAMPLE 9

Six multi-layer tubes are used for a performance study of the life of different silicone formulation covers. Specifically, various silicone formulations are tested as covers over a sodium-naphthalene etched heat-shrinkable PTFE liner (2:1 H/S ratio; obtained from Teleflex). The silicone rubber covers are obtained from Wacker (product 3003/50), GE (self-bonding product LIMS 8040) and Shin Etsu (self-bonding product Shincore 2090). 3003-50+VEE-005 is Wacker LSR and a vinyl-containing silsesquioxane obtained from Gelest added at 0.75 wt % of the LSR to produce a self-bonding formulation. 3003-50+VPE-005 is Wacker LSR and a vinylpropyl silsesquioxane obtained from Gelest added at 1.50 wt % of the LSR to produce a self-bonding formulation. Further, the first silicone tube is a tube made from Wacker product 3003/50 without a liner.

Life of the silicone rubber tubing is tested on either a standard pump head or Easy-Load II head at 600 rpm and zero backpressure.

FIG. 11 illustrates the affects of the three different liners on the life of silicone rubber tubing. Both the formulations containing the silsesquioxanes outperform the commercially available GE self-bonding LSR as well as the conventional LSRs. The multi-layer tube using Gelest VPE-005 has a life of greater than about 275 hours. The multi-layer tube using Gelest VEE-005 has a life of greater than about 350 hours and outperforms the commercially available Shin-Etsu self-bonding LSR.

### EXAMPLE 10

Two tubes are selected for a study of treatment time and temperature on peel strength of etched liners. Specifically, a Santoprene cover (product 8291-65) is used over an etched PTFE liner (Zeus High Flex Life) and the tube is heated in 50 foot coiled lengths at varying times and varying temperatures to determine optimal adhesion to improve the life of the tubes. The Santoprene cover is extruded over the PTFE liner which is etched with either sodium-ammonia or sodium-naphthalene. The peel test uses an Instron 4465 testing machine which is equipped with a stationary horizontal clamping platform. The horizontal platform is used to clamp the liner in a horizontal position. The jacket material is then clamped into the Instron grip. The grip then transverses in the vertical direction at the rate of two in/min, which pulls the jacket material 90° from the liner surface. The samples have a width of one inch, an approximate liner thickness of 0.008″ to 0.012″ and an approximate jacket thickness of 0.052″ to 0.056″.

FIG. 12 illustrates the performance of the tube with varying process temperatures for a heating time of 10 minutes at each temperature. The sodium-ammonia etch and process temperature of 175° C. is optimum. At temperatures greater than 200° C. the Santoprene cover begins to melt.

FIG. 13 illustrates the performance of the tube with varying process times at a heating temperature of 175° C. The sodium-ammonia etch is optimum. Optimal adhesion is achieved after 20 minutes post-treatment time.

### EXAMPLE 11

Three liners are selected for a study of the crystallinity of the material. Specifically, liners include commercially available PTFE, such as standard PTFE from Zeus (Teflon Tubing), a high flex life PTFE (Zeus tubing using High Flex Life resin), and a Heat-Shrink PTFE (2:1 H/S ration; obtained from Teleflex). The materials are tested using a DSC TA Q100. The samples are sealed into aluminum pans and inserted in the DSC cell. The heat flow is measured as ramping from 25° C. to 400° C.@20° C./min under nitrogen for heating/cooling/heating cycles.

It is well known that crystallinity affects flexibility of polymer materials. As the crystallinity increases, the material becomes less flexible. DSC is a know technique to compare the crystallinity of like materials; the larger the change in enthalpy value at the crystallization peak, the higher the crystallinity. This value is also referred to as the heat of fusion.

TABLE 3
DSC Data for Fluoropolymer Liners.

| | ΔH1 (J/g) | ΔH2 (J/g) |
|---|---|---|
| Standard PTFE | 37 | 40 |
| High Flex | 30 | 32 |
| Heat-Shrink | 25 | 40 |

Table 3 includes the change in enthalpy at the crystallization peak in units of joules/gram. The change in enthalpy value is recorded for each of the liners for the first and second heating cycles, which are denoted as ΔH1 and ΔH2. ΔH1 represents the crystallinity of the liner material initially and ΔH2 represents the crystallinity of the material after one heating and cooling cycle of 400° C.

The Heat-Shrink PTFE has lower crystallinity than both the High Flex and Standard PTFE. In particular the Heat-Shrink PTFE is about 30% less crystalline than standard PTFE and about 15% less crystalline than High Flex PTFE. High Flex PTFE is about 20% less crystalline than Standard PTFE.

### EXAMPLE 12

Four tubes are selected for a performance study of liner type. Specifically, two tubes include a Santoprene cover (product 8291-65) over two different etched PTFE liners (Zeus High Flex and Teleflex 2:1 Heat-Shrink). The tubes are post-treated at 150° C. for 60 minutes. The Santoprene cover is continuously extruded over the PTFE liner which is etched with sodium-ammonia. The second two tubes include a silicone LSR cover over two different etched PTFE liners (Zeus High Flex and Teleflex 2:1 Heat-Shrink). The silicone LSR is a 50 durometer material which contains a vinyl-containing silsesquioxane which is used as an adhesion promoter. The vinyl-containing silsesquioxane is VEE-005 obtained from Gelest. The liners are chemically etched with sodium-naphthalene and subsequently, the silicone rubber cover is extruded over the liner. All liners have an approximate thickness of 0.008″ to 0.012″ while all jacket has an approximate thickness of 0.052″ to 0.056″. The performance test is performed on a Masterflex Easy-Load II Pump at 400 rpm.

FIG. 14 illustrates the performance of the tubes with varying jacket and liner materials. The tubes which have the High Flex Liner and Santoprene jacket have the highest life out of all tubes. For a silicone jacket, the highest pump life is the tubes which contain the Heat-Shrink liners. In an embodiment, a highly flexible liner such as Heat-Shrink PTFE decreases the life of a Santoprene jacketed tube but increased the life of a Silicone jacketed tube. Hence, the performance of tubes with less flexible jacketing materials, such as Santoprene, may be adversely affected with the use of a low crystalline and highly flexible PTFE liner, such as Heat-Shrink PTFE. As such, the flexibility of the jacketing material has to be matched with the flexibility of the liner.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of forming a multi-layer tube comprising:
providing a heat-shrinkable fluoropolymer liner; and
extruding an elastomeric cover over the heat-shrinkable fluoropolymer liner.

2. The method of claim 1, wherein the liner includes an outer surface, the method further comprising treating the outer surface prior to the step of extruding the elastomeric cover.

3. The method of claim 2, wherein treating the outer surface includes chemical etching, physical-mechanical etching, plasma etching, corona treatment, chemical vapor deposition, or combinations thereof.

4. (canceled)

5. (canceled)

6. The method of claim 1, wherein the heat-shrinkable fluoropolymer liner is paste extruded prior to extruding the elastomeric cover.

7. The method of claim 1, wherein the heat-shrinkable fluoropolymer liner includes a fluoropolymer selected from the group consisting of a polytetrafluoroethylene (PTFE), fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), an ethylene tetrafluoroethylene copolymer (ETFE), an ethylene chlorotrifluoroethylene copolymer (ETFE), polychlorotrifluoroethylene (PCTFE), polyvinylidene fluoride (PVDF), and a tetrafluoroethylene hexafluoropropylene vinylidene fluoride terpolymer (THV).

8. The method of claim 7, wherein the heat-shrinkable fluoropolymer is polytetrafluoroethylene.

9. The method of claim 8, wherein the heat-shrinkable polytetrafluoroethylene has a tensile modulus of less than 3000 psi.

10. The method of claim 1, wherein the heat-shrinkable fluoropolymer has a crystallinity of not greater than about 25 Joules/gram as indicated by differential scanning calorimetry.

11. The method of claim 1, wherein the elastomer is selected from the group consisting of silicone elastomer, a diene elastomer, and a blend of a polyolefin and diene elastomer.

12. (canceled)

13. (canceled)

14. The method of claim 1, further comprising heating the multi-layer tube to a temperature of about 125° C. to about 200° C.

15. The method of claim 14, wherein heating includes heating for a time of about 5 minutes to about 10 hours.

16. The method of claim 15, wherein heating is performed without mounting the tube on a mandrel.

17. The method of claim 1, wherein extruding includes continuously extruding to a length of up to at least about 25 feet.

18. A tube comprising:
a first layer comprising heat-shrinkable polytetrafluoroethylene; and
a second layer adjacent the first layer, the second layer comprising an elastomer.

19. The tube of claim 18, wherein the heat-shrinkable polytetrafluoroethylene has a stretch ratio not greater than about 4:1.

20-42. (canceled)

43. A method of forming a multi-layer tube comprising:
providing a non-fibrillated, high flex fluoropolymer liner; and
extruding an elastomeric cover over the non-fibrillated, high flex fluoropolymer liner.

44-51. (canceled)

52. The method of claim 43, wherein the non-fibrillated, high flex fluoropolymer has a crystallinity of up to about 32 Joules/gram as indicated by differential scanning calorimetry.

53-59. (canceled)

60. A tube comprising:
a first layer comprising non-fibrillated, high flex fluoropolymer; and
a second layer adjacent the first layer, the second layer comprising an elastomer.

61. The tube of claim 60, wherein the non-fibrillated, high flex fluoropolymer has a flex cycle greater than 3.0 million cycles with a load of 4.5 pounds.

62-72. (canceled)

73. The tube of claim 69, wherein the silicone elastomer includes self-bonding high consistency rubber and self-bonding liquid silicone rubber.
